(19) United States
(12) Patent Application Publication
(10) Pub. No.: US 2021/0381802 A1
(43) Pub. Date: Dec. 9, 2021

(54) Reusable Retainer Band for Firearm Slings, Wires, and Accessories

(71) Applicant: Charlton R. Pope, Iron Mountain, MI (US)

(72) Inventor: Charlton R. Pope, Iron Mountain, MI (US)

(21) Appl. No.: 17/339,730

(22) Filed: Jun. 4, 2021

Related U.S. Application Data
(60) Provisional application No. 63/034,591, filed on Jun. 4, 2020.

(51) Int. Cl. F41C 33/00

(52) U.S. Cl. CPC F41C 33/002

(57) ABSTRACT

Devices and methods are provided as an environmentally conscious way to replace standard rubber bands. The devices include a reusable retainer band that comprises of a breakaway feature. The device further includes a wrap near the buckle to provide rigidity. The methods of use provide steps to use a device to loop around a firearm to secure wires, straps, or accessories.

### CROSS-REFERENCE TO RELATED APPLICATIONS

This application claims priority to and the benefit of U.S. Provisional Application Ser. No. 63/034,591, filed Jun. 4, 2020, which is hereby incorporated by reference herein in its entirety.

### TECHNICAL FIELD

This disclosure relates to an environmentally conscious way to replace standard rubber bands.

### BACKGROUND

Rubber bands have been used in many forms and fashions; from retaining cables and wires, managing camera gear, utilizing with outdoor equipment, law enforcement, military, and first responder applications (such as radio equipment and tourniquets), sealing bags, and other practical uses.

The reusable retainer band can be used in many forms and fashions, replacing standard rubber bands. Used by both military and Law Enforcement to manage cables for their radio equipment, rifle slings, cables for lights/night vision devices, and medical supplies. Benefits over alternative items used are the breakaway feature preventing snags, the reusability and durability, versatility, and adjustability.

The standard reusable retainer band's break strength is about the same as the failure point of a household rubber band, however different tensile strengths can be achieved by slight changes in plastic shape/density/stiffness.

Sling retention bands have been used specifically to attach and carry slings and wires on a firearm.

Rubber bands without a break-away buckle with a loop where the cord is looped through break after sufficient force is applied. In addition, without a liner or shrink applied, standard rubber bands lack rigidity.

### BRIEF DESCRIPTION OF THE DRAWINGS

FIG. 1 is a perspective view of the Reusable Retainer Band according to one or more embodiments of the disclosure.

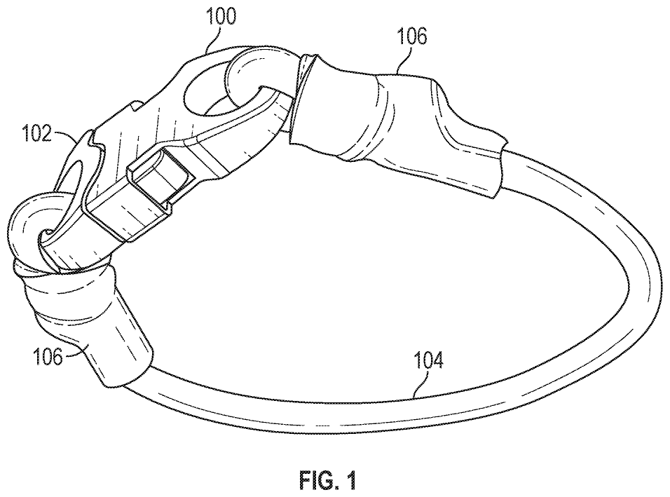

FIG. 2 shows the break-down of components in the Reusable Retainer Band prior to assembly in a manner showing the relative location of where each part will be according to one or more embodiments of the disclosure.

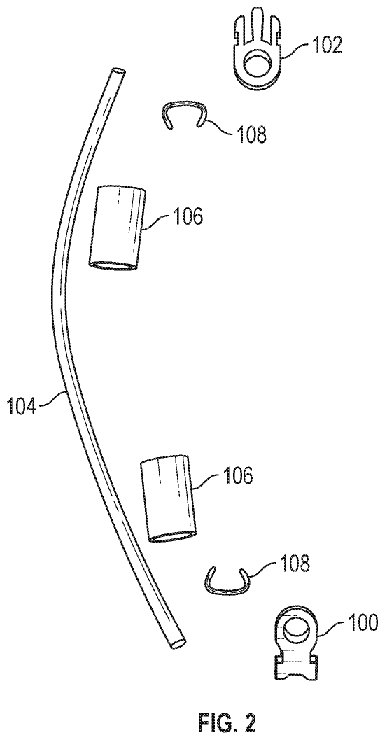

FIG. 3 shows an embodiment of the Reusable Retainer Band in its final assembled stage, unclasped, ready for use. The cord is looped through the hole in the clasp and then fastened with the hog rings on both ends before being secured further with dual walled heat shrink according to one or more embodiments of the disclosure.

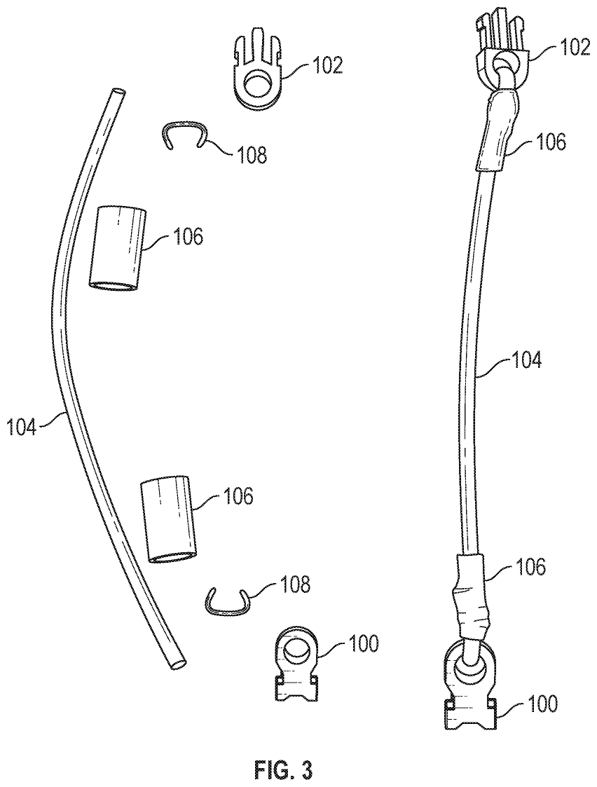

FIG. 4 shows an embodiment of the Reusable Retainer Band clasped to form a loop, demonstrating how the retainer would look in common use according to one or more embodiments of the disclosure.

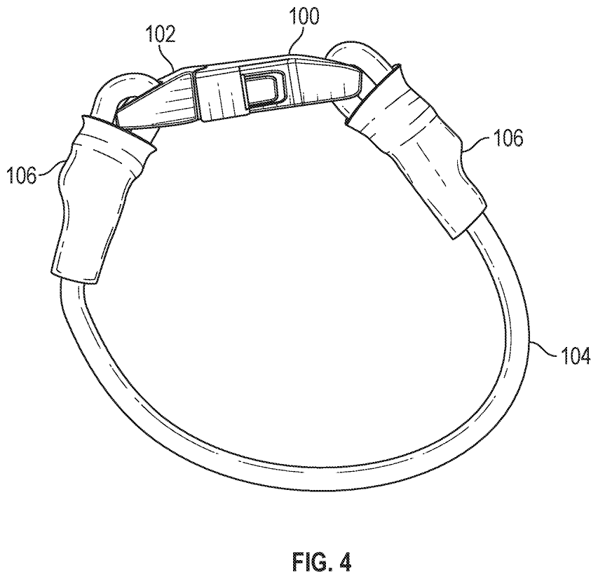

FIGS. 5a, 5b, and 5c, show an embodiment of the Reusable Retainer Band with a magnetic clasp in a disengaged, engaged, and engaged on a loop view respectively.

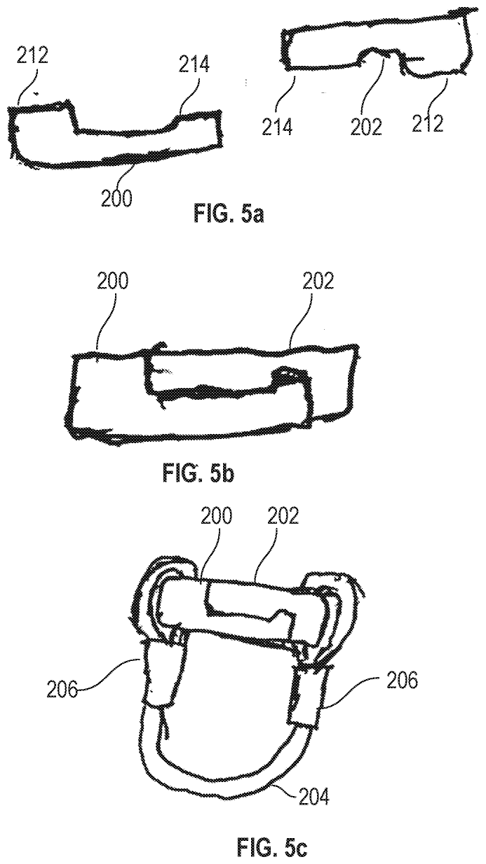

FIGS. 6a, 6b, and 6c show an embodiment of the Reusable Retainer Band with a wedge insertion for adjustable strength.

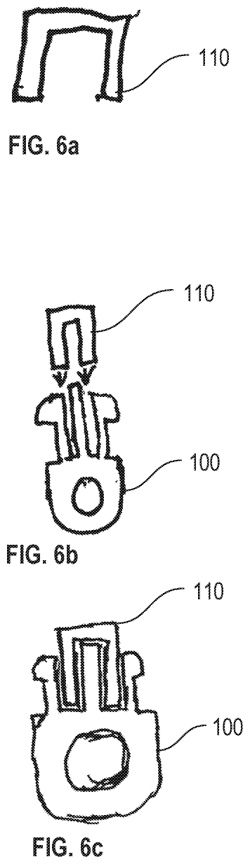

### DETAILED DESCRIPTION

Aspects of the disclosure allow for reusability and improved rigidity in parts of the band covered in heat shrink.

This disclosure utilizes a length of bungee/shock cord (a band or bands of rubber enclosed in woven fabric), hog rings to hold the cord in place, and a break-away buckle with a loop where the cord is looped through. After the cord is looped and attached via hog ring, dual-walled heat shrink is then applied over the cord and ring to prevent damage from the metal of the hog ring. In some embodiments, construction includes, but is not limited to, the metal or plastic buckle or clasp being attached to the band and being secured by way of a metal or plastic clamp, protected by dual-walled, adhesive lined, heat shrink to not only further secure the clamp and add rigidity, but protect other components from scratches; all while offering a retaining band that can be used time and time again.

In some embodiments, reusable retainer band may be used in many forms and fashions; from retaining cables and wires, managing camera gear, utilizing with outdoor equipment, law enforcement, military, and first responder applications (such as radio equipment and tourniquets), sealing bags, and any other practical use you can find for this that would replace a standard rubber band. Some embodiments offer retention up to a similar breaking point of a standard rubber band, at which point the buckle gives way and releases the tension.

Length, thickness, and color of cord can vary depending on the application.

The female end of the buckle 100 can be comprised of metal, plastic, or combinations thereof, or magnetic. Embodiments of the locking between the female end of the buckle 100 and male end of the buckle 102 can be, but are not limited to, a D-ring, where a threaded pin can be inserted and screwed into place to be secured. The buckles may be at least side-release buckles, center push buckles, or button buckles. In some embodiments, adjustable break strength is controlled by way of insertion of a rubber wedge with different hardness options, different band tensions allowing for more stretch before breaking, or alternative magnet strengths, or static break strength. The wedge can be inserted into the male end of a side-release buckle to increase and adjust the break strength. At least the hardness and size of the wedge affects the change in break strength.

In some embodiments with magnetic buckles, spacers can be inserted between the magnetic surfaces to further adjust the break force. A coating or wrap can be applied to the buckle to prevent scratching of a firearm. The magnetic buckles can meet end-to-end or overlap in a loop. The magnetic buckles can also be attached via interlocking L shaped mechanisms to provide further mechanical retention. In some embodiments, the magnetic buckle can be separated by pulling laterally, axially, or through a switch or disengage mechanism attached to the magnetic buckle.

The male end of the buckle 102 can be comprised of metal, plastic, or combinations thereof, or magnetic. Embodiments of the locking between the female end of the buckle 100 and male end of the buckle 102 can be, but are not limited to, using a clasp, pin, or threaded pin. The buckles may be at least side-release buckles, center push buckles, or button buckles. In some embodiments, adjustable break strength is controlled by way of insertion of a rubber wedge 110 with different hardness options, different band tensions allowing for more stretch before breaking, or alternative magnet strengths, or static break strength. The rubber wedge 110 could be inserted into the male portion of the buckle to adjust the break strength.

The band 104, in some embodiments, can be shock/bungee cord, flat elastic, or 550 cord, elastic band(s) wrapped in woven fabric such as, but not limited to, cotton, nylon, or Kevlar, can be used. Other types of cord, such as 550 cord, paracord, or flat elastic bands can be used in place.

In some embodiments, the heat shrink 106 can be dual or single wall and with or without adhesive, with 2 pieces. Alternative embodiments can include, but aren't limited to, rubberized coatings such as Plasti-Dip® coating or adhesives or similar products, tapes, a thread wrap woven over top, leather, hard or soft plastic coatings, or Velcro® for security upon break-away.

In some embodiments, the band is secured by a hog ring 108 to the female end of the buckle 100 and male end of the buckle 102. Alternative embodiments include plastic clamps or clasps, staples, or stitching that can be used to secure the band 104 around the female end of the buckle 100 and male end of the buckle 102. In another embodiment the clamps can be galvanized or manual clamps.

In some embodiments, the buckle can comprise a first magnetic buckle 200 and a second magnetic buckle 202, configured to fit together. The magnetic buckles have a hole 212 where the band can be looped through and attached. A magnet 214 on the magnetic buckles connects the two buckles.

In some embodiments, the heat shrink 206 can be dual or single wall and with or without adhesive, with 2 pieces. Alternative embodiments can include, but aren't limited to, rubberized coatings such as Plasti-Dip® coating or adhesives or similar products, tapes, a thread wrap woven over top, leather, hard or soft plastic coatings, or Velcro® for security upon break-away.

The band 204, in some embodiments, can be shock/bungee cord, flat elastic, or 550 cord, elastic band(s) wrapped in woven fabric such as, but not limited to, cotton, nylon, or Kevlar, can be used. Other types of cord, such as 550 cord, paracord, or flat elastic bands can be used in place.

Reusable Retainer Bands can easily be secured end to end in order to create a longer band if so desired. Using multiple strings bands linked together, then woven or braided into one strand, will create a stronger, thicker, and more sturdy band.

In one embodiment, the adjustable break-point of the buckles can be adjusted by using a side-release buckle. The thickness of the side clips in a side-release buckle predicts a general weight for breakage, and adjusting the thickness adjusts the breakaway force for the buckle, allowing for an adjustable break force of the band.

In one embodiment, the adjustable break-point of the buckle can be adjusted by using magnetic clips. Different strength magnets adjust the breakaway force for the buckle, allowing for an adjustable break force of the band.

In one embodiment, the reusable retainer band can be attached to a firearm to attach and hold slings, wires, or other accessories to the firearm as a sling retention band. The reusable retainer band has an adjustable break force, and sufficient force on the sling, wires, or other accessories will break release the buckle at the adjustable break force.

In some embodiments, additional pieces for attachment to gear can be a piece of both hook and pile tape, secured to one another by way of adhesive, stitch, heat, or fastener, looped around the e Reusable Retainer Band, then secured again by way of adhesive, stitch, heat, or fastener, forming an open ended loop that can then be secured by placing the hook tape to the pile tape to gear, MOLLE loops, cables, clothes, or other object.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

Wherefore, I claim:

1. A reusable retainer band for use with a firearm, comprising:
a band having a first end and a second end;
a first side release buckle attached to the first end of the band; and
a second side release buckle attached to the second end of the band, the second buckle configured to mate with the first buckle;
wherein the first buckle and the second buckle have an adjustable break force that is adjustable between at least a first force and a second force, wherein the first force is greater than the second force.

2. The reusable retainer band of claim 1, further comprising a coating on a first portion of the band near the first buckle and on a second portion of the band near the second buckle.

3. The reusable retainer band of claim 2, wherein the coating is a heat shrink.

4. The reusable retainer band of claim 2, wherein the coating is a rubberized coating.

5. The reusable retainer band of claim 2, wherein the coating is a thread wrap.

6. The reusable retainer band of claim 2, wherein the coating is hard or soft plastic.

7. The reusable retainer band of claim 2, wherein the coating is leather.

8. The reusable retainer band of claim 2, wherein the coating is velcro.

9. The reusable retainer band of claim 2, wherein the coating is tape.

10. The reusable retainer band of claim 1, wherein the band is comprised of shock or bungee cord.

11. The reusable retainer band of claim 1, wherein the band is comprised of 550 cord.

12. The reusable retainer band of claim 1, wherein the band is comprised of flat elastic or a first elastic band and a second elastic band.

13. The reusable retainer band of claim 1, wherein the band is comprised of material from the group of: shock or bungee cord, flat elastic, 550 cord, or at least one elastic band, wherein the material comprising the band is wrapped in woven fabric selected from the group of: cotton, nylon, or Kevlar.

14. A reusable retainer band for use with a firearm, comprising a first reusable retainer band of claim 1 and a second reusable retainer band of claim 1 connected by the first end of the first reusable retainer band to the second end of the second reusable retainer band.

15. Reusable retainer bands for use with a firearm, comprising:
a first band having a first end and a second end;
a first buckle attached to the first end of the first band; and
a second buckle attached to the second end of the first band, the second buckle configured to mate with the first buckle;
wherein the first buckle of the first band and the second buckle of the first band have a first break force;
a second band having a first end and a second end;
a first buckle attached to the first end of the second band; and
a second buckle attached to the second end of the second band, the second buckle of the second band configured to mate with the first buckle of the second band;
wherein the first buckle and the second buckle have a second break force; and
wherein the first break force is greater than the second break force.

16. The reusable retainer band of claim 15, wherein the first buckle is attached to the first end of the band and second buckle is attached to the second end of the band by hog ring, clamps, clasps, staples, or stitching.

17. The reusable retainer band of claim 15, wherein the adjustable break force is controlled by insertion of a rubber wedge with different hardness options, different band tensions allowing for more stretch before breaking, alternative magnet strengths, or static break strengths.

18. The reusable retainer band of claim 15, further comprising a piece of both hook and pile tape looped around the reusable retainer band to form an open ended loop.

19. The reusable retainer band of claim 14, wherein the first buckle is magnetic, the second buckle is magnetic, and the adjustable break force is configured by adjusting the type and strength of magnet used for the buckle.

20. A method of using a reusable retainer band for use with a firearm, comprising the steps of:
adjusting a break force of a side release buckle by selecting the thickness of the side clips;
mating a female side release buckle with a male side release buckle; and
looping the reusable retainer band around a firearm.
